(19) United States
(12) Patent Application Publication
(10) Pub. No.: US 2010/0048770 A1
(43) Pub. Date: Feb. 25, 2010

(54) CYCLOALIPHATIC POLYURETHANE COMPOSITION CONTAINING CYCLOALIPHATIC DIALDIMINES

(75) Inventor: Urs Burckhardt, Zurich (CH)

Correspondence Address: OLIFF & BERRIDGE, PLC, P.O. BOX 320850, ALEXANDRIA, VA, 22320-4850, US

(73) Assignee: Sika Technology AG, BAAR (CH)

(21) Appl. No.: 12/450,264

(22) PCT Filed: Mar. 27, 2008
(86) PCT No.: PCT/EP2008/053631

§ 371 Date: Sep. 23, 2009

(30) Foreign Application Priority Data
Mar. 27, 2007 (EP) 07105002.5

(51) Int. Cl. C08L 3/00; C08G 18/00; C08L 75/04; C08K 3/26; B05D 3/00; B29C 65/52

(52) U.S. Cl. 524/47; 525/452; 525/456; 524/589; 524/423; 524/425; 427/331; 156/307.3

(57) ABSTRACT

The invention relates to polyurethane compositions which comprise at least one cycloaliphatic isocyanate group bearing polyurethane polymer P and at least on cycloaliphatic dialdimine. Compositions of this type are especially suitable as elastic adhesives and sealing agents and as coating materials and are characterized by their photostability and good storage stability while having good processing properties. The compositions according to the invention cure quickly, without forming bubbles and giving off odors. When cures, they are highly stable and have little surface tack and little tendency to exudates components that are capable of migration.

### TECHNICAL FIELD

The invention relates to the field of polyurethane compositions which are used especially as elastic adhesives, sealants and coatings.

### STATE OF THE ART

Moisture-curing compositions based on polyurethane polymers having isocyanate groups have been used for some time as elastic adhesives, sealants and coatings. These polyurethane polymers are typically formed from polyols, especially polyether- or polyesterpolyols, and polyisocyanates. The polyisocyanates used are often aromatic polyisocyanates. Such polyurethane polymers based on aromatic polyisocyanates, however, have a tendency to discolor, or to yellow, under the influence of light and heat. They are therefore unusable for applications where the color stability of the product is important, for example in floor coverings which are colored in light shades or are transparent, or light-colored visible joints.

Proceeding from aliphatic, especially cycloaliphatic, polyisocyanates, color-stable polyurethane compositions are obtainable. Such cycloaliphatic polyurethane compositions, however, have disadvantages. Their curing rate is significantly slower and their mechanical stability and hardness in the cured state is lower compared to compositions based on aromatic polyisocyanates.

With the use of capped amines, so-called “latent hardeners”, in moisture-curing polyurethane compositions, it is possible to increase the rate of curing and additionally to suppress the formation of bubbles. Such latent hardeners, for example polyoxazolidines, polyketimines or polyaldimines, however, usually bring the disadvantage of releasing, as they cure, volatile and odor-intensive elimination products, especially aldehydes or ketones, and/or of lowering the storage stability of the composition. While U.S. Pat. No. 4,469,831 describes a moisture-curing one-component polyurethane composition which has a higher storage stability in some cases, there remains the great disadvantage that the aldehyde eliminated has a strong, clearly perceptible odor.

WO 2004/013200 A1 discloses moisture-curing polyurethane compositions comprising specific odor-free polyaldimines which are storage-stable and cure without bubbles or odor formation. In the course of the curing reaction, these polyaldimines release a nonvolatile aldehyde as an elimination product, which remains in the hardened composition and exerts a softening influence there. Proceeding from the polyaldimines disclosed in WO 2004/013200, moisture-curing polyurethane compositions based on aliphatic polyisocyanates are obtainable with a higher curing rate. However, the problem of the relatively low mechanical strength and hardness of such yellowing-free polyurethane compositions has not been solved.

### SUMMARY OF THE INVENTION

It is therefore an object of the present invention to provide a polyurethane composition which is yellowing-free in the cured state, which cures rapidly and possesses a high hardness and strength, and additionally has good storage stability and good processibility, and cures without bubbles or intense odor formation.

It has now been found that, surprisingly, a composition as claimed in claim 1 has the desired properties. This composition is based on a combination of polyurethane polymers having cycloaliphatic isocyanate groups and dialdimines proceeding from cycloaliphatic diamines.

The composition as claimed in claim 1 cures rapidly and substantially loses its surface tack as it does so. After it has been cured, the composition exhibits unexpectedly high hardness and strength, which could not be expected on the basis of the compositions described in the prior art. It is thus outstandingly suitable as a coating, especially as a floor covering, and as an adhesive or sealant.

Moreover, it has been found that, surprisingly, the composition as claimed in claim 1 exhibits a significantly lower tendency to exude, as a result of migration, liquid constituents not bound within the polymer, especially the aldehydes used to prepare the cycloaliphatic dialdimines, and plasticizers whose presence is optional, as is the case for comparable prior art compositions which contain noncycloaliphatic dialdimines or no dialdimines. As a result, a composition as claimed in claim 1 has a lesser tendency, after being applied, for example as a joint sealant, to be soiled on the surface by adhering impurities, especially dusts, or to leave behind spots on the substrates.

The composition is also storage-stable, cures without significant odor formation and without bubbles, and does not tend to yellow under the influence of light and heat.

Further aspects of the invention are the subject-matter of further independent claims. Particularly preferred embodiments of the invention are the subject-matter of the dependent claims.

### WAYS OF PERFORMING THE INVENTION

The present invention provides, in a first aspect, compositions comprising at least one polyurethane polymer P which has cycloaliphatic isocyanate groups, and at least one cycloaliphatic dialdimine of the formula (I).

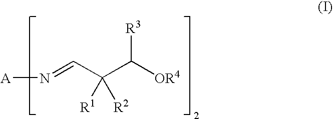

The R¹ and R² radicals are each independently a monovalent hydrocarbon radical having 1 to 12 carbon atoms, or together are a divalent hydrocarbon radical which has 4 to 20 carbon atoms and is part of an optionally substituted carbocyclic ring having 5 to 8, preferably having 6, carbon atoms. R¹ and R² are preferably each methyl groups.

The R³ radical is a hydrogen atom or an alkyl or arylalkyl group, especially having 1 to 12 carbon atoms, especially a hydrogen atom.

The R⁴ radical is a hydrocarbon radical which has 6 to 30 carbon atoms and optionally contains heteroatoms or is a radical of the formula (II).

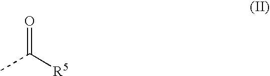

In this formula, the R⁵ radical is either a linear or branched alkyl radical having 6 to 30 carbon atoms, optionally having cyclic components and optionally having at least one heteroatom, especially oxygen in the form of ether, ester or aldehyde groups, or is a mono- or polyunsaturated linear or branched hydrocarbon radical having 6 to 30 carbon atoms, or is an optionally substituted aromatic or heteroaromatic 5- or 6-membered ring. R⁴ is preferably a radical of the formula (II), where R⁵ is especially an alkyl group having 11 to 30 carbon atoms, preferably having 11 carbon atoms.

Most preferred are cycloaliphatic dialdimines of the formula (I), in which R¹ and R² are each methyl groups, R³ is a hydrogen atom and R⁴ is a radical of the formula (II), where R⁵ is an alkyl group having 11 to 30 carbon atoms, especially having 11 carbon atoms.

In addition, A in the cycloaliphatic dialdimine of the formula (I) is the radical of a cycloaliphatic primary diamine after removal of the two primary amino groups, where this radical does not have any moieties which are reactive with isocyanate groups.

More particularly, A contains no hydroxyl groups, no primary or secondary amino groups, no mercapto groups, no urea groups and no other groups with active hydrogen.

In the present document, substance names beginning with “poly”, such as polyisocyanate or polyol, denote substances which, in a formal sense, contain two or more of the functional groups which occur in their name per molecule.

In the present document, the term “polymer” firstly embraces a collective of macromolecules which are chemically homogeneous but different in relation to degree of polymerization, molar mass and chain length, which has been prepared by a poly reaction (polymerization, polyaddition, polycondensation). The term secondly also embraces derivatives of such a collective of macromolecules from poly reactions, i.e. compounds which have been obtained by reactions, for example additions or substitutions, of functional groups on given macromolecules, and which may be chemically homogeneous or chemically inhomogeneous. The term further also comprises what are known as prepolymers, i.e. reactive oligomeric preliminary adducts whose functional groups are involved in the formation of macromolecules.

The term “polyurethane polymer” embraces all polymers prepared by what is known as the diisocyanate polyaddition process. This also includes those polymers which are virtually or entirely free of urethane groups. Examples of polyurethane polymers are polyetherpolyurethanes, polyesterpolyurethanes, polyetherpolyureas, polyureas, polyesterpolyureas, polyisocyanurates and polycarbodiimides.

The term “cycloaliphatic primary diamine” here and hereinafter denotes a diamine which has two primary amino groups bonded to a hydrocarbon radical which is cycloaliphatic or has cycloaliphatic components.

In the present document, the term “active hydrogen” denotes a deprotonatable hydrogen atom bonded to a nitrogen, oxygen or sulfur atom.

The cycloaliphatic dialdimine of the formula (I) can be prepared by a condensation reaction between at least one cycloaliphatic primary diamine of the formula H₂N-A-NH₂ and at least one aldehyde of the formula (III).

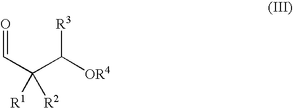

Suitable cycloaliphatic primary diamines of the formula H₂N-A-NH₂ are, for example, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, produced by Mitsui Chemicals), 3(4),8(9)-bis(aminomethyl)tricyclo-[5.2.1.0^{2,6}]decane or 3,9-bis(3-aminopropyl)-2,4,8,10-tetraoxaspiro[5.5]-undecane.

Preferred cycloaliphatic primary diamines of the formula H₂N-A-NH₂ are those in which at least one of the amino groups is bonded directly to a cycloaliphatic ring. Such preferred cycloaliphatic primary diamines are especially selected from the group consisting of 1,2-diaminocyclohexane (DCH), 1,3-diaminocyclohexane, 1,4-diaminocyclohexane, bis(4-aminocyclohexyl)methane (H₁₂MDA), bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (IPDA), 2,2′-, 2,4′- and 4,4′-diaminobicyclohexyl, 2- and 4-methyl-1,3-diaminocyclohexane and 1,4-diamino-2,2,6-trimethylcyclohexane. Preference is given to DCH, 1,3-diaminocyclohexane, 1,4-diaminocyclohexane, IPDA, H₁₂MDA and bis(4-amino-3-methylcyclohexyl)methane. Most preferred are IPDA and H₁₂MDA.

To prepare a cycloaliphatic dialdimine of the formula (I), typically aldehydes of the formula (III) are used. These aldehydes have the property that their R¹, R², R³ and R⁴ radicals have no moieties which are reactive with isocyanate groups. More particularly, R¹, R², R³ and R⁴ have no hydroxyl groups, no primary or secondary amino groups, no mercapto groups, no urea groups and no other groups with active hydrogen.

In a first embodiment, suitable aldehydes of the formula (III) are aldehydes which bear, as the R⁴ radical, a hydrocarbon radical which has 6 to 30 carbon atoms and optionally contains heteroatoms. They are ethers of aliphatic, arylaliphatic or cycloaliphatic 2,2-disubstituted 3-hydroxyaldehydes with phenols or alcohols, for example fatty alcohols. Suitable 2,2-disubstituted 3-hydroxyaldehydes are in turn obtainable from aldol reactions, especially crossed aldol reactions, between primary or secondary aliphatic aldehydes, especially formaldehyde, and secondary aliphatic, secondary arylaliphatic or secondary cycloaliphatic aldehydes, for example isobutyraldehyde, 2-methylbutyraldehyde, 2-ethylbutyraldehyde, 2-methylvaleraldehyde, 2-ethylcapronaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde (hydratropaldehyde) or diphenylacetaldehyde. Especially suitable aldehydes are 2,2-dimethyl-3-lauroxypropanal and 2,2-dimethyl-3-stearoxypropanal.

In a second preferred embodiment, suitable aldehydes of the formula (III) are compounds of the formula (IV),

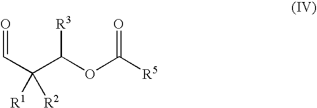

where R¹, R², R³ and R⁵ are each as already defined.

Compounds of the formula (IV) are esters which are especially prepared from the reaction of the 2,2-disubstituted 3-hydroxyaldehydes already described, for example 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethyl-cyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal, with suitable carboxylic acids.

Examples of suitable carboxylic acids are saturated aliphatic carboxylic acids such as 2-ethylcaproic acid, enanthic acid, caprylic acid, pelargonic acid, capric acid, undecanoic acid, lauric acid, tridecanoic acid, myristic acid, penta-decanoic acid, palmitic acid, margaric acid, stearic acid, nonadecanoic acid, arachic acid; monounsaturated aliphatic carboxylic acids such as palmitoleic acid, oleic acid, erucic acid; polyunsaturated aliphatic carboxylic acids such as linoleic acid, linolenic acid, eleostearic acid, arachidonic acid; cycloaliphatic carboxylic acids such as cyclohexanecarboxylic acid; arylaliphatic carboxylic acids such as phenylacetic acid; aromatic carboxylic acids such as benzoic acid, naphthoic acid, toluic acid, anisic acid; isomers of these acids; fatty acid mixtures from the industrial hydrolysis of natural oils and fats, for example rapeseed oil, sunflower oil, linseed oil, olive oil, coconut oil, oil palm kernel oil and oil palm oil; and monoalkyl and monoaryl dicarboxylates as obtained from the monoesterification of dicarboxylic acids such as succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, hexahydroterephthalic acid, 3,6,9-trioxaundecanedioic acid and similar derivatives of polyethylene glycol, with alcohols such as methanol, ethanol, propanol, butanol, higher homologs and isomers of these alcohols.

Preferred aldehydes of the formula (IV) are 3-benzoyloxy-2,2-dimethylpropanal, 3-cyclohexanoyloxy-2,2-dimethylpropanal, 2,2-dimethyl-3-(2-ethylhexyloxy)propanal, 2,2-dimethyl-3-lauroyloxypropanal, 2,2-dimethyl-3-myristoyloxypropanal, 2,2-dimethyl-3-palmitoyloxypropanal, 2,2-dimethyl-3-stearoyloxypropanal, and analogous esters of other 2,2-disubstituted 3-hydroxyaldehydes.

In a particularly preferred embodiment, R⁴ is a radical of the formula (II) where R⁵ is selected from the group consisting of phenyl, cyclohexyl, 2-ethylhexyl and the C₁₁-, C₁₃-, C₁₅- and C₁₇-alkyl groups.

Particular preference is given to 2,2-dimethyl-3-lauroyloxypropanal.

In a preferred method for preparing an aldehyde of the formula (IV), a 2,2-disubstituted 3-hydroxyaldehyde, for example 2,2-dimethyl-3-hydroxypropanal, which can be prepared, for example, from formaldehyde (or paraformaldehyde) and isobutyraldehyde, optionally in situ, is reacted with a carboxylic acid to give the corresponding ester. This esterification can be effected without the use of solvents by known methods. These are described, for example, in Houben-Weyl, “Methoden der organischen Chemie” [Methods of Organic Chemistry], Vol. VIII, pages 516-528.

To prepare an aldehyde of the formula (IV) whose R⁵ radical has at least one heteroatom, especially oxygen in the form of ether, ester or aldehyde groups, the 2,2-disubstituted 3-hydroxyaldehyde is reacted either with a carboxylic acid which contains the corresponding functional groups or with a dicarboxylic acid. For example, the esterification of two 2,2-disubstituted 3-hydroxyaldehydes with an aliphatic or cycloaliphatic dicarboxylic acid, for example succinic acid, glutaric acid, adipic acid, azelaic acid, sebacic acid or cyclohexanedioic acid, affords the corresponding aliphatic or cycloaliphatic dialdehyde of the formula (V),

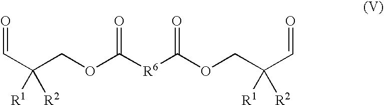

where R⁶ is the hydrocarbon radical of the dicarboxylic acid.

In a particularly preferred embodiment, the aldehydes of the formula (III) are odorless. An “odorless” substance is understood to mean a substance which is so low-odor that most humans cannot smell it, i.e. is not nasally perceptible.

Odorless aldehydes of the formula (III) are firstly aldehydes of the formula (III), which bear, as the R⁴ radical, a hydrocarbon radical which has 11 to 30 carbon atoms and optionally contains heteroatoms; and secondly aldehydes of the formula (IV) which, as the R⁵ radical, have either a linear or branched alkyl radical having 11 to 30 carbon atoms, optionally having cyclic components and optionally having at least one heteroatom, especially oxygen in the form of ether, ester or aldehyde groups, or for a mono- or polyunsaturated, linear or branched hydrocarbon radical having 11 to 30 carbon atoms.

Examples of such odorless aldehydes are esterification products of the 2,2-disubstituted 3-hydroxyaldehydes already mentioned with carboxylic acids, for example lauric acid, tridecanoic acid, myristic acid, pentadecanoic acid, palmitic acid, margaric acid, stearic acid, nonadecanoic acid, arachic acid, palmitoleic acid, oleic acid, erucic acid, linoleic acid, linolenic acid, eleostearic acid, arachidonic acid, fatty acids from the industrial hydrolysis of natural oils and fats, for example rapeseed oil, sunflower oil, linseed oil, olive oil, coconut oil, oil palm kernel oil and oil palm oil, and industrial mixtures of fatty acids which comprise these acids. Preferred odorless aldehydes of the formula (IV) are 2,2-dimethyl-3-lauroyloxypropanal, 2,2-dimethyl-3-myristoyloxypropanal, 2,2-dimethyl-3-palmitoyloxypropanal and 2,2-dimethyl-3-stearoyloxypropanal. Particular preference is given to 2,2-dimethyl-3-lauroyloxypropanal.

The cycloaliphatic dialdimine of the formula (I) used may also be mixtures of different cycloaliphatic dialdimines, especially also mixtures of different dialdimines formed from different cycloaliphatic primary diamines of the formula H₂N-A-NH₂ and different or identical aldehydes of the formula (III) or (IV).

The cycloaliphatic dialdimines of the formula (I) have the property that they cannot form tautomeric enamines, since they do not bear a hydrogen as a substituent in the a position to the carbon atom of the aldimino group. Such aldimines form storable mixtures together with polyurethane polymers P, even if highly reactive isocyanate groups are present therein.

In addition, the cycloaliphatic dialdimines of the formula (I) have the property that they are low-odor or odorless, and that the aldehyde of the formula (III) or (IV) used in the preparation thereof is low-odor or odorless.

In the course of curing of the composition, the elimination product released is the aldehyde used to prepare the cycloaliphatic dialdimine of the formula (I), i.e. an aldehyde of the formula (III) or (IV). By virtue of the cycloaliphatic dialdimines of the formula (I) and these aldehydes being low-odor or odorless, compositions which cure without significant odor formation are obtainable. When exclusively the described odorless embodiments of these aldehydes are used to prepare the cycloaliphatic dialdimines of the formula (I), compositions which cure odorlessly are obtainable.

The polyurethane polymer P is typically prepared from at least one polyol and at least one cycloaliphatic diisocyanate.

The polyols used for the preparation of a polyurethane polymer P may, for example, be the following commercially available polyols or mixtures thereof:
polyetherpolyols, also known as polyoxyalkylenepolyols or oligoetherols, which are polymerization products of ethylene oxide, 1,2-propylene oxide, 1,2- or 2,3-butylene oxide, oxetane, tetrahydrofuran or mixtures thereof, possibly polymerized with the aid of a starter molecule with two or more active hydrogen atoms, for example water, ammonia or compounds having a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the compounds mentioned. It is possible to use either polyoxyalkylenepolyols which have a low degree of unsaturation (measured to ASTM D-2849-69 and reported in milliequivalents of unsaturation per gram of polyol (meq/g)), prepared, for example, with the aid of double metal cyanide complex catalysts (DMC catalysts), or polyoxyalkylenepolyols with a higher degree of unsaturation, prepared, for example, with the aid of anionic catalysts such as NaOH, KOH, CsOH or alkali metal alkoxides.

Particularly suitable are polyoxyethylenepolyols and polyoxypropylenepolyols, especially polyoxyethylenediols, polyoxypropylenediols, polyoxyethylenetriols and polyoxypropylenetriols.

Especially suitable are polyoxyalkylenediols or polyoxyalkylenetriols having a degree of unsaturation lower than 0.02 meq/g and having a molecular weight in the range from 1000 to 30 000 g/mol, and also polyoxyethylenediols, polyoxyethylenetriols, polyoxypropylenediols and polyoxypropylenetriols with a molecular weight of 400 to 8000 g/mol. “Molecular weight” or “molar mass” is understood in the present document always to mean the molecular weight average Mₙ.

Likewise particularly suitable are so-called ethylene oxide-terminated (“EO-endcapped”, ethylene oxide-endcapped) polyoxypropylenepolyols. The latter are specific polyoxypropylene-polyoxyethylenepolyols which are obtained, for example, by further alkoxylating pure polyoxypropylenepolyols, especially polyoxypropylenediols and -triols, with ethylene oxide on completion of the polypropoxylation reaction, and have primary hydroxyl groups as a result. Preference is given in this case to polyoxypropylenepolyoxyethylenediols and polyoxypropylene-polyoxyethylenetriols.
Styrene-acrylonitrile- or acrylonitrile-methyl methacrylate-grafted polyether-polyols.
Polyesterpolyols, also known as oligoesterols, prepared, for example, from di- to trihydric alcohols, for example 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, with organic dicarboxylic acids or the anhydrides or esters thereof, for example succinic acid, glutaric acid, adipic acid, suberic acid, azelaic acid, sebacic acid, dodecanedicarboxylic acid, maleic acid, fumaric acid, phthalic acid, isophthalic acid, terephthalic acid and hexahydrophthalic acid, or mixtures of the aforementioned acids, and also polyesterpolyols formed from lactones, for example from ε-caprolactone.
Polycarbonatepolyols, as obtainable by reaction, for example, of the abovementioned alcohols—used to form the polyesterpolyols—with dialkyl carbonates, diaryl carbonates or phosgene.
Polyacrylate- and polymethacrylatepolyols.
Poly-hydroxy-functional fats and oils, for example natural fats and oils, especially castor oil; or polyols—known as oleochemical polyols—obtained by chemical modification of natural fats and oils, for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are especially fatty acids and fatty alcohols, and also fatty acid esters, especially the methyl esters (FAME), which can be derivatized, for example, by hydroformylation and hydrogenation to hydroxy fatty acid esters.
Polyhydrocarbonpolyols, also known as oligohydrocarbonols, for example poly-hydroxy-functional ethylene-propylene, ethylene-butylene or ethylene-propylene-diene copolymers, as produced, for example, by Kraton Polymers, or poly-hydroxy-functional copolymers of dienes such as 1,3-butadiene or diene mixtures, and vinyl monomers such as styrene, acrylonitrile or isobutylene, or poly-hydroxy-functional polybutadienepolyols, for example those which are prepared by copolymerization of 1,3-butadiene and allyl alcohol and may also be hydrogenated.
Poly-hydroxy-functional acrylonitrile/butadiene copolymers, as can be prepared, for example, from epoxides or amino alcohols and carboxyl-terminated acrylonitrile/butadiene copolymers (commercially available under the Hycar® CTBN name from Noveon).

These polyols mentioned preferably have a mean molecular weight of 250-30 000 g/mol, especially of 1000-30 000 g/mol, and preferably have a mean OH functionality in the range from 1.6 to 3.

Particularly suitable polyols are polyesterpolyols and polyetherpolyols, especially polyoxyethylenepolyol, polyoxypropylenepolyol and polyoxy-propylenepolyoxyethylenepolyol, preferably polyoxyethylenediol, polyoxypropylenediol, polyoxyethylenetriol, polyoxypropylenetriol, polyoxy-propylenepolyoxyethylenediol and polyoxypropylenepolyoxyethylenetriol.

In addition to these polyols mentioned, small amounts of low molecular weight di- or polyhydric alcohols, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned di- and polyhydric alcohols, and mixtures of the aforementioned alcohols, can be used additionally in the preparation of the polyurethane polymer P.

The cycloaliphatic diisocyanates used to prepare the polyurethane polymer P may be commercially available cycloaliphatic diisocyanates which are especially selected from the group consisting of cyclohexane 1,3-diisocyanate, cyclohexane 1,4-d iisocyanate, 1-isocyanato-3,3,5-trimethyl-5-iso-cyanatomethylcyclohexane (IPDI), perhydro-2,4′-diphenylmethane diisocyanate, perhydro-4,4′-diphenylmethane diisocyanate, 1,4-diisocyanato-2,2,6-trimethylcyclohexane, 2-methyl-1,3-diisocyanatocyclohexane and 4-methyl-1,3-diisocyanatocyclohexane, especially IPDI, perhydro-2,4′-diphenylmethane diisocyanate and perhydro-4,4′-diphenylmethane diisocyanate, preferably IPDI.

In addition, it is possible to use mixtures of polyurethane polymers P, especially mixtures of a room temperature-liquid polyurethane polymer P with a room temperature-solid polyurethane polymer P.

The proportion of the polyurethane polymer P which has cycloaliphatic isocyanate groups is preferably 10 to 95% by weight, especially 15 to 80% by weight, based on the overall composition.

The proportion of the cycloaliphatic dialdimine of the formula (I) is preferably such that the ratio between the aldimino groups and the isocyanate groups of the polyurethane polymer P is 0.1 to 1.1, especially 0.15 to 1.0, preferably 0.2 to 0.9.

The composition preferably further comprises a filler. The filler influences both the rheological properties of the uncured composition, and the mechanical properties and the surface properties of the cured composition. Suitable fillers are inorganic and organic fillers, for example natural, ground or precipitated calcium carbonates which are optionally coated with fatty acids, especially stearates, barium sulfate (BaSO₄, also known as barite or heavy spar), calcined kaolins, quartz flour, aluminum oxides, aluminum hydroxides, silicas, especially high-dispersity silicas from pyrolysis processes, carbon blacks, especially industrially produced carbon black, PVC powders or hollow spheres. Preferred fillers are barium sulfate and calcium carbonates, carbon black and flame-retardant fillers such as hydroxides or hydrates, especially hydroxides or hydrates of aluminum, preferably aluminum hydroxide.

It is quite possible and may even be advantageous to use a mixture of different fillers.

A suitable amount of filler is, for example, in the range from 10 to 70% by weight, preferably 20 to 60% by weight, based on the overall composition.

The composition may comprise a solvent, or else may not. When the composition comprises a solvent, it should be ensured that this solvent does not have any groups reactive with isocyanate groups, more particularly no hydroxyl groups and no other groups with active hydrogen.

Suitable solvents are especially selected from the group consisting of ketones such as acetone, methyl ethyl ketone, diisobutyl ketone, acetylacetone, mesityl oxide, cyclohexanone and methylcyclohexanone; esters, for example acetates such as ethyl acetate, propyl acetate and butyl acetate, formates, propionates and malonates such as diethyl malonate; ethers such as dialkyl ethers, ketone ethers and ester ethers, for example diisopropyl ether, diethyl ether, dibutyl ether, diethylene glycol diethyl ether and ethylene glycol diethyl ether; aliphatic and aromatic hydrocarbons such as toluene, xylene, heptane, octane, and mineral oil fractions such as naphtha, white spirit, petroleum ether and gasoline; halogenated hydrocarbons such as methylene chloride; and N-alkylated lactams, for example N-methylpyrrolidone.

Preference is given to xylene, toluene, white spirit and mineral oil fractions in the boiling range from 100° C. to 200° C.

Suitable amounts of solvent are typically in the range from 1 to 50% by weight, especially from 1 to 25% by weight, based on the overall composition.

Further constituents may be present in the composition. Further constituents are especially assistants and additives such as:
Plasticizers, for example esters of organic carboxylic acids or anhydrides thereof, for example phthalates such as dioctyl phthalate, diisononyl phthalate or diisodecyl phthalate, adipates such as dioctyl adipate, azelates and sebacates; organic phosphoric and sulfonic esters, polybutenes and polyisobutenes;
Catalysts as are customary in polyurethane chemistry, especially tin and bismuth compounds, tertiary amines, organic carboxylic and sulfonic acids;
Fibers, for example of polyethylene;
Pigments, for example titanium dioxide or iron oxides;
Rheology modifiers, for example thickeners or thixotropic agents, for example urea compounds, polyamide waxes, bentonites or fused silicas;
Reactive diluents or crosslinkers, for example low molecular weight oligomers and derivatives of diisocyanates such as MDI, PMDI, TDI, HDI, 1,12-dodecamethylene diisocyanate, cyclohexane 1,3-diisocyanate or cyclohexane 1,4-diisocyanate, IPDI, perhydro-2,4′-diphenylmethane diisocyanate and perhydro-4,4′-diphenylmethane diisocyanate, 1,3- and 1,4-tetramethylxylylene diisocyanate, especially isocyanurates, carbodiimides, uretonimines, biurets, allophanates and iminooxadiazinediones of the diisocyanates mentioned, adducts of diisocyanates with short-chain polyols, adipic dihydrazide and other dihydrazides, and capped amines in the form of polyaldimines, polyketimines, oxazolidines or polyoxazolidines;
Desiccants, for example molecular sieves, calcium oxide, high-reactivity isocyanates such as p-tosyl isocyanate, orthoformic esters, alkoxysilanes such as tetraethoxysilane, organoalkoxysilanes such as vinyltrimethoxy-silane, and organoalkoxysilanes which have a functional group in the a position to the silane group;
Adhesion promoters, especially organoalkoxysilanes, referred to hereinafter as “silanes”, for example epoxysilanes, vinylsilanes, (meth)acrylsilanes, isocyanatosilanes, carbamatosilanes, S-(alkylcarbonyl)mercaptosilanes and aldiminosilanes, oligomeric forms of these silanes, and adducts of aminosilanes and/or mercaptosilanes with polyisocyanates;
Nonreactive thermoplastic polymers, for example homo- or copolymers of unsaturated monomers, especially of unsaturated monomers which are selected from the group comprising ethylene, propylene, butylene, isobutylene, isoprene, vinyl acetate or higher esters thereof, and (meth)acrylate, particularly suitable examples being ethylene-vinyl acetate copolymers (EVA), atactic poly-α-olefins (APAO), polypropylenes (PP) and polyethylenes (PE);
Reactive thermoplastic polymers, especially isocyanate-terminated polyurethane polymers, which are prepared using polyesterpolyols, preferably room temperature solid polyesterpolyols, and whose melting point is in the region of the application temperature of the composition as a warm-melt adhesive, preferably between 40° C. and 80° C.;
Stabilizers against heat, light and UV radiation;
Flame-retardant substances;
Surface-active substances, for example wetting agents, leveling agents, deaerating agents or defoamers;
Biocides, for example algicides, fungicides or substances which inhibit fungal growth;
   and further substances which are used customarily in polyurethane compositions.

Also advantageously, the composition comprises at least one catalyst which accelerates the hydrolysis of the aldimine groups and/or the reaction of the isocyanate groups.

Catalysts which accelerate the hydrolysis of the dialdimine are, for example, organic carboxylic acids such as benzoic acid or salicylic acid, organic carboxylic anhydrides such as phthalic anhydride or hexahydrophthalic anhydride, silyl esters of organic carboxylic acids, organic sulfonic acids such as p-toluenesulfonic acid or 4-dodecylbenzenesulfonic acid, sulfonic esters, other organic or inorganic acids, or mixtures of the aforementioned acids and acid esters.

Catalysts which accelerate the reaction of the isocyanate groups with water are, for example, organotin compounds such as dibutyltin dilaurate, dibutyltin dichloride, dibutyltin diacetylacetonate, organobismuth compounds or bismuth complexes, or amine-containing compounds, for example 2,2′-dimorpholinodiethyl ether or 1,4-diazabicyclo[2.2.2]octane, or other catalysts which are customary in polyurethane chemistry for the reaction of the isocyanate groups.

It may be advantageous when a mixture of a plurality of catalysts is present in the polyurethane composition, especially a mixture of an acid and an organometallic compound or a metal complex, of an acid and an amino-containing compound, or a mixture of an acid, an organometallic compound or a metal complex, and an amino-containing compound.

A typical catalyst content is typically 0.005 to 2% by weight, based on the overall composition, it being clear to the person skilled in the art which amounts are advisable for use with which catalysts.

It is advantageous to select all of said constituents which may be present in the composition, especially a filler and a catalyst, such that the storage stability of the composition is not adversely affected by the presence of such a constituent, which means that the properties of the composition, especially the application and curing properties, change only slightly, if at all, in the course of storage. This has the effect that reactions which lead to chemical curing of the composition described, especially of isocyanate groups, do not occur to a significant degree during the storage. It is therefore especially advantageous that the constituents mentioned contain, or release in the course of storage, at most traces of water, if any. It may therefore be advisable to chemically or physically dry certain constituents before they are mixed into the composition.

The composition described is prepared and stored with exclusion of moisture. The composition is storage-stable, which means that it can be stored with exclusion of moisture in a suitable package or arrangement, for example a vat, a bag or a cartridge, over a period of several months up to one year and longer, without its performance properties or its properties after curing changing to a degree relevant for the use thereof. Typically, the storage stability is determined via the measurement of the viscosity or of the pressing-out force.

When the composition is contacted with moisture, it begins, caused by chemical reactions of the aldimino and the isocyanate groups, to cure and hence to gain its end strength. A further aspect of the present invention thus relates to a cured composition which is obtained from the reaction of water, especially in the form of air humidity, with an above-described composition. The aldimino groups of the cycloaliphatic dialdimine of the formula (I) have the property of being hydrolyzed on contact with moisture. The free amino groups which form in a formal sense react with the isocyanate groups present in the composition to form urea groups and release aldehydes of the formula (III).

The isocyanate groups are preferably in stoichiometric excess relative to the aldimino groups. These excess isocyanate groups of the composition react directly with moisture and form urea groups with elimination of carbon dioxide. As a result of this and any further reactions of the isocyanate groups, the composition cures. This process is also referred to as crosslinking. The cycloaliphatic dialdimine of the formula (I) is incorporated into the cured polyurethane matrix in the course of curing with release of the aldehyde used to prepare it. The reaction of the isocyanate groups with the dialdimine being hydrolyzed need not necessarily proceed via free amino groups. It will be appreciated that reactions of intermediates which occur in the course of hydrolysis are also possible. For example, it is conceivable that an aldimino group being hydrolyzed in the cycloaliphatic dialdimine of the formula (I) reacts directly with an isocyanate group in the form of a hemiaminal group.

The composition is used especially as a one-component composition and is moisture-curing. The water required for the curing may either originate from the air (air humidity), or else the above-described composition can be contacted with a water-containing component, for example by painting, for example with a smoothing agent, or by spraying, or a water-containing component can be added to the composition in the course of application, for example in the form of a water-containing paste which is mixed, in for example, by means of a static mixer. In the course of curing by means of air humidity, the composition cures from the outside inwards. The rate of curing is determined by various factors, for example the diffusion rate of the water, the temperature, the ambient moisture and the adhesive geometry; it generally slows as the curing progresses.

When only odor-free aldehydes such as those described above are released in the course of curing of the composition, the curing of the composition does not give rise to a troublesome odor, which is a greater advantage or even a prerequisite for many applications, especially in interiors.

The composition described cures rapidly on contact with moisture, for example with water, and without the formation of bubbles. The cured composition is substantially yellowing-free—even under the influence of light and heat. This enables its use in adhesives, sealants and coatings which are used in a transparent appearance or in pale shades and should therefore be color-stable.

In the course of curing of the composition, the surface tack thereof decreases very rapidly. This is unusual and surprising for a polyurethane composition which is formed from polyurethane polymers having cycloaliphatic isocyanate groups, especially those based on IPDI. The tack of a customary composition of this kind, especially in the application as an elastic adhesive or sealant, is often very marked and does not decrease until a few days or even weeks after application, which makes the composition prone to soiling, especially by dusts.

After curing, the composition described possesses the same good extensibility coupled with a remarkably high hardness and strength, which is surprising for a polyurethane composition formed from polyurethane polymers having cycloaliphatic isocyanate groups, especially those based on IPDI. Their tensile strength and Shore hardness are significantly higher than those of comparable polyurethane compositions formed from polyurethane polymers having cycloaliphatic isocyanate groups and dialdimines proceeding from noncycloaliphatic diamines. Such an improvement in strength and hardness which arises from the use of the cycloaliphatic dialdimines of the formula (I) was not to be expected from the prior art.

Moreover, the composition described exhibits a low tendency to exude, as a result of migration, liquid constituents which are not bound within the polymer after the curing thereof, especially the aldehydes of the formulae (III), (IV) and/or (V) used to prepare the cycloaliphatic dialdimines of the formula (I), and plasticizers whose presence is optional. This is surprising to the person skilled in the art since significantly greater exudation of the migrating constituents is observed in the case of comparable prior art compositions which comprise noncycloaliphatic dialdimines or no dialdimines at all. This may especially also be true of comparable compositions which comprise aldimines which are based on the same aldehydes as the dialdimines of the formula (I), i.e. aldehydes of the formulae (III), (IV) and/or (V). It is suspected that, in the composition described, the lower tendency to exudation of the migrating constituents is attributable to the fact that the latter, especially the aldehydes, have significantly better compatibility with the polymer matrix, especially the cycloaliphatic urea groups.

The lower exudation of migrating constituents in combination with the rapid curing of the composition described substantially prevents the surface of the composition from remaining tacky over a long period after the application thereof, and hence soil and dusts from adhering thereon. Moreover, fewer spots and stains, if any, occur on the surface of the composition and on the substrate to which the composition has been applied than in customary prior art compositions. Spots and stains on substrates resulting from migrating constituents, also referred to as “bleeding”, occur especially in the case of sealing of joints adjoining fine-pore materials, especially concrete, cements or natural rocks such as marble and granite, since these substrate can readily absorb such migrating constituents owing to their fine pores. Moreover, the exudation of migrating constituents is problematic in the case of coatings which are subsequently to be sealed, since the migration of plasticizer-like substances into the surface seal or through it not only severely impairs the visual appearance of the overall coating, but can even soften the seal to such an extent that it is substantially destroyed. Additionally problematic is the exudation of migrating constituents in the case of joints on which a paint or adhesive overcoat is subsequently to be applied to the adhesive joint, since the exuded film can impair the adhesion to the paint or to the adhesive at the joint.

According to the constituents and the amounts thereof, the composition has a different consistency and different properties in the uncured and cured states. This is characteristic of the particular application of the composition described.

The present invention further encompasses the use of an above-described composition as an adhesive, sealant and/or as a coating for construction and industrial applications.

In one embodiment, the composition has a fluid consistency with good leveling properties at room temperature. As a result, it can be applied easily as a self-leveling coating to predominantly flat surfaces, for example as a floor covering. The composition can be applied in a plurality of layers. Typically a layer thickness of 0.5 to 3 mm, especially of 0.5 to 2 mm, is applied per layer.

In another embodiment, the composition has a pasty consistency with structurally viscous properties at room temperature and is typically suitable as an adhesive and/or sealant, especially as an elastic adhesive or sealant.

In a specific embodiment, the composition has a room temperature solid meltable component which is preferably a reactive or nonreactive thermoplastic polymer as described above and, for better handling, is preferably applied warm, i.e. at a temperature above the melting point of the meltable component. As a result, the curing is effected by two operations. Firstly, the composition solidifies in the course of cooling, by virtue of the meltable component, especially the polyurethane polymer P, solidifying, especially as a result of crystallization, thus significantly increasing the viscosity of the composition. This physical curing ends the open time from a certain time and gives rise to the early strength of the composition. In parallel, the chemical curing of the composition is effected by means of moisture, as already described, associated with the development of the final strength.

In the embodiment described above, the composition is preferably used as an adhesive or as a sealant, especially as an elastic adhesive or sealant.

In the fully cured state, the above-described composition possesses elastic properties coupled with a high strength. This means that it firstly has high extensibility, typically of >300%, and secondly a high tensile strength, typically of >2 MPa.

The present invention further also encompasses a process for adhesive bonding of a substrate S1 and of a substrate S2. Such a process for adhesive bonding comprises the steps of
i) applying a composition as described above to a substrate S1 and/or a substrate S2;
ii) contacting the substrates S1 and S2 via the composition applied; and
iii) curing the composition applied by means of water, especially in the form of air humidity;
   where the substrates S1 and S2 are the same or different from one another.

The adhesive is applied especially in the form of so-called triangular beads. Owing to their consistency, which imparts a certain early strength to them, both adhesive and sealant can be applied to surfaces with any spatial alignment, i.e. also to vertical and overhanging surfaces. For better handling in the course of application, the composition preferably also has thixotropic behavior and short threading.

The composition described can also be used as a warm-melt adhesive.

In the application as a warm-melt adhesive, the composition is heated before application to a temperature above the melting point of the polyurethane polymer P, or of the solid component, especially between 40° C. and 100° C. The subsequent adhesive bonding is effected by the process described above.

The present invention further also comprises a process for sealing. Such a process comprises the steps of
i′) applying a composition as described above between a substrate S1 and a substrate S2; and
ii′) curing the composition applied by means of water, especially in the form of air humidity;
   where the substrates S1 and S2 are the same or different from one another.

The present invention further also comprises a process for producing a coating, especially a floor covering. Such a process comprises the steps of
i″) applying a composition as described above to a substrate S1, and
ii″) curing the composition applied by means of water, especially in the form of air humidity.

With regard to steps iii), ii′) or ii″) of the chemical curing of the composition with moisture, the person skilled in the art understands that the curing reaction, depending on factors such as the composition used, the substrates, the temperature, the ambient humidity and the adhesive geometry, may begin as early as during the application of the composition. The main part of the chemical curing generally takes place, however, after the application of the composition.

Suitable substrates S1 and/or S2 are especially substrates which are selected from the group consisting of concrete, cement, mortar, brick, tile, gypsum, natural stone, asphalt, metal, metal alloy, wood, ceramic, glass, plastic, powder coating, paint and lacquer.

If required, the substrates S1 and/or S2 can be pretreated before the application of the above-described composition. Such pretreatments include especially physical and/or chemical cleaning methods, for example grinding, sandblasting, brushing or the like, or treatment with detergents or solvents, or a flaming or a plasma treatment, especially an air plasma pretreatment at atmospheric ambient pressure. In addition, the substrates S1 and/or S2 may have pretreatments, for example in the form of an undercoat. Examples of useful undercoats include adhesion promoter compositions or primers.

The composition is particularly suitable for odor-sensitive applications, for example the sealing of joints in the interior of buildings, the production of coatings or floors in interiors, and the adhesive bonding of components in the interior of vehicles. Preferred coatings are protective paints, seals, protective coatings and primer coatings. Preferred coverings are particularly floor coverings. For example, such floor coverings are used for offices, living areas, hospitals, schools, warehouses, garages and other domestic or industrial applications. These applications are over a large area, which can lead to occupational hygiene difficulties and/or odor nuisance in the case of customary compositions corresponding to the prior art, even in the case of applications outdoors. Moreover, a majority of the floor coverings is applied indoors. Therefore, the odor in the case of floor coverings is generally a great problem which, however, can be alleviated with the inventive compositions.

The described composition for adhesive bonding and/or sealing of substrates S1 and/or S2 is applied typically from commercially available cartridges which, for smaller applications, are preferably operated manually. Application by means of compressed air from a cartridge or from a vat or hobbock by means of a delivery pump or of an extruder, if appropriate by means of an application robot, is likewise possible. Such application methods are preferred especially in applications in industrial manufacture or in the case of large applications.

The application of the composition described to produce a coating is effected typically by pouring onto the substrate S1 to be coated, especially onto a floor, and is distributed homogeneously in the liquid state with the aid, for example, of a coating knife or of a notched trowel. In addition, the material can be leveled and deaerated with a spiked roller. However, machine application, for example in the form of a spray application, is also possible.

It is also possible that the composition described, before application, is mixed with a further filler, especially quartz sand. It is likewise possible to scatter quartz sand only onto or into the surface of the still-liquid composition. In both ways, a sandy, abrasion-resistant surface with good skidproofing is obtained, which can be sealed if required.

In addition, the composition can be applied in one or more layers. In the case of multilayer application, the process of application is repeated several times in immediate succession or at particular time intervals.

Finally, the application of the composition described can be followed by application of a seal, which, in a thin layer, for example in a thickness of a few micrometers to a few tenths of a millimeter, once again influences the surface properties of the floor covering. This may be a transparent or pigmented seal. It is also possible that an antiwear layer is additionally applied to a cured layer of an inventive composition which has a high elongation at break. This gives rise to a covering with good dynamic crack bridging and high surface hardness, the inventive composition with its high elasticity ensuring crack bridging, and the antiwear layer imparting the high surface hardness. The antiwear layer in turn may also be sealed if required. In this way, floor structures can be maintained according to OS 11 of the “Richtlinie für Schutz und lnstandsetzung von Betonbauteilen” [Guidelines for Protection and Maintenance of Concrete Components] of the German Committee for Reinforced Concrete, where “OS” stands for “Oberflächenschutzsystem” [Surface protection system].

The present invention further comprises an article adhesively bonded, sealed and/or coated with a described composition, which is obtained by one of the processes described.

These articles are preferably a building or a built structure in construction or civil engineering, an industrially manufactured good or a consumer good, especially a window, a domestic appliance or a mode of transport, especially a vehicle, or an installable component of a vehicle.

These articles are preferably floors, typically in the interior and in the exterior of buildings or built structures, for example floors of offices, industrial halls, gymnasiums, chill rooms, balconies, terraces, bridges, parking decks, or sports grounds and playgrounds.

### EXAMPLES

### Description of the Test Methods

Infrared spectra were measured on an FT-IR 1600 instrument from Perkin-Elmer (horizontal ATR analysis unit with ZnSe crystal); the substances were applied undiluted as a film. The absorption bands are reported in wavenumbers (cm⁻¹) (measurement window: 4000−650 cm⁻¹).

¹H NMR spectra were measured on a Bruker DPX-300 spectrometer at 300.13 MHz; the chemical shifts δ are reported in ppm relative to tetramethylsilane (TMS), coupling constants J are reported in Hz. True coupling patterns and pseudo coupling patterns were not distinguished.

The viscosity was measured on a thermostated Physica UM cone-plate viscometer (cone diameter 20 mm, cone angle 1°, cone tip-plate distance 0.05 mm, shear rate 10 to 1000 s⁻¹).

The amine content of the dialdimines prepared, i.e. the content of capped amino groups in the form of aldimino groups, was determined titrimetrically (with 0.1N HClO₄ in glacial acetic acid, using crystal violet), and is always reported in mmol N/g.

### a) Preparation of Dialdimines

Dialdimine A-1 (Corresponding to the Formula (I))

A round-bottom flask was initially charged under a nitrogen atmosphere with 55.0 g (0.19 mol) of distilled 2,2-dimethyl-3-lauroyloxypropanal. With vigorous stirring, 15.6 g (0.18 mol of N) of 1-amino-3-aminomethyl-3,5,5-trimethylcyclohexane (=isophoronediamine, IPDA; Vestamin® IPD, Degussa; amine content 11.68 mmol N/g) were added slowly from a dropping funnel, in the course of which the mixture heated up and became increasingly cloudy. Thereafter, the volatile constituents were removed under reduced pressure (10 mbar, 80° C.). Yield: 67.1 g of a clear colorless oil with an amine content of 2.73 mmol N/g and a viscosity of 190 mPa·s at 20° C.

IR: 2952, 2922, 2852, 2819sh, 1738 (C═O), 1666 (C═N), 1464, 1418, 1394, 1378, 1364, 1350, 1298, 1248, 1236sh, 1158, 1112, 1048, 1020, 1000, 938, 928, 910, 894, 868, 772, 722.

¹H NMR (CDCl₃, 300 K): δ 7.59 and 7.57 (2×s, total 1H, CH═N ([isomers]), 7.47 (s, 1H, CH═N), 4.03 and 4.01 (2×s, 2×2H, C(CH₃)₂—CH₂—O), 3.37 (m, 1H, N—CH^{Cy}), 3.08 (dd, 2H, J≈11.1, N—CH₂—C^{Cy}), 2.30 (t, 4H, J≈7.5, OC(O)—CH₂—CH₂), 1.61 (m, 4H, OC(O)—CH₂—CH₂), 1.60-0.85 (m, 65H, remaining CH).

Dialdimine A-2 (corresponding to the formula (I))

A round-bottom flask was initially charged under a nitrogen atmosphere with 50.0 g (0.18 mol) of distilled 2,2-dimethyl-3-lauroyloxy-propanal and admixed at room temperature with 17.9 g (0.17 mol of N) of solid bis(4-aminocyclohexyl)methane (H₁₂MDA; isomer mixture; amine content 9.37 mmol N/g). This went into solution completely after a short time, and the mixture heated up and became increasingly cloudy. Thereafter, the volatile constituents were removed under reduced pressure (10 mbar, 80° C.). Yield: 64.7 g of a clear, brown-orange oil with an amine content of 2.60 mmol N/g and a viscosity of 460 mPa·s at 20° C.

IR: 2952sh, 2920, 2851, 2818sh, 1737 (C═O), 1665 (C═N), 1466, 1449, 1418, 1394, 1375, 1345, 1300, 1248, 1233, 1159, 1112, 1056, 1019, 1000, 938, 913, 896, 766, 721.

¹H NMR (CDCl₃, 300 K): δ 7.55 and 7.53 (2×s, ratio approx. 7/3; 2H, CH═N), 4.02 and 4.00 (2×s, ratio approx. 3/7; 4H, C(CH₃)₂—CH₂—O), 3.09 and 2.88 (2×m, ratio approx. 3/7; 2H, N—CH^{Cy}), 2.29 (t, 4H, J≈7.5, OC(O)—CH₂—CH₂), 1.89 and 1.75 (2×m, ratio approx. 3/7; 4 Cy-H), 1.65-1.40 (m, 16H, 12 Cy-H and OC(O)—CH₂—CH₂), 1.35-0.90 (m, 36H, 4 Cy-H and CH₃—(CH₂)₈—CH₂—CH₂—CO), 1.08 (s, 12H, C(CH₃)₂—CH₂—O), 0.88 (t, 6H, J≈6.9, CH₃—(CH₂)₁₀—CO).

Dialdimine A-3 (Corresponding to the Formula (I))

A round-bottom flask was initially charged under a nitrogen atmosphere with 60.5 g (0.21 mol) of distilled 2,2-dimethyl-3-lauroyloxy-propanal. With vigorous stirring, 11.6 g (0.20 mol of N) of 1,2-diamino-cyclohexane (DCH; Dytek® DCH-99, Invista; amine content 17.34 mmol N/g) were added slowly from a dropping funnel, in the course of which the mixture heated up and became increasingly cloudy. Thereafter, the volatile constituents were removed under reduced pressure (10 mbar, 80° C.). Yield: 68.2 g of a clear, almost colorless oil with an amine content of 2.94 mmol N/g and a viscosity of 80 mPa·s at 20° C.

IR: 2952sh, 2922, 2852, 1738 (C═O), 1666 (C═N), 1466, 1418, 1392, 1374, 1344, 1300, 1246, 1234, 1158, 1112, 1082, 1018, 1000, 932, 858, 846, 830, 802, 766, 722, 676.

Dialdimine A-4 (Corresponding to the Formula (I))

A round-bottom flask was initially charged under a nitrogen atmosphere with 50.0 g (0.18 mol) of distilled 2,2-dimethyl-3-lauroyloxy-propanal. With vigorous stirring, 19.8 g (0.17 mol of N) of bis(4-amino-3-methylcyclohexyl)methane (Laromin® C 260, BASF; amine content 8.46 mmol N/g) were added slowly from a dropping funnel, in the course of which the mixture heated up and became increasingly cloudy. Thereafter, the volatile constituents were removed under reduced pressure (10 mbar, 80° C.).

Yield: 66.5 g of a clear, colorless oil with an amine content of 2.50 mmol N/g.

IR: 2952sh, 2920, 2852, 2815sh, 1738 (C═O), 1666 (C═N), 1456, 1418, 1394, 1370, 1344, 1299, 1248, 1234, 1158, 1112, 1046, 1020, 1000, 936, 922, 875, 863, 850, 764, 722.

Dialdimine A-5 (Corresponding to the Formula (I))

A round-bottom flask was initially charged under a nitrogen atmosphere with 80.9 g (0.27 mol) of distilled 2,2-dimethyl-3-lauroyloxy-propanal. With vigorous stirring, 25.2 g (0.26 mol of N) of 3(4),8(9)-bis(amino-methyl)tricyclo[5.2.1.0^{2,6}]decane (TCD-diamine, celanese; amine content 10.23 mmol N/g) were added slowly from a dropping funnel, in the course of which the mixture heated up and became increasingly cloudy. Thereafter, the volatile constituents were removed under reduced pressure (10 mbar, 80° C.).

Yield: 100.8 g of a clear, almost colorless oil with an amine content of 2.56 mmol N/g.

Dialdimine A-6 (Corresponding to the Formula (I))

A round-bottom flask was initially charged under a nitrogen atmosphere with 45.0 g (0.16 mol) of distilled 2,2-dimethyl-3-lauroyloxy-propanal. With vigorous stirring, 19.2 g (0.15 mol of N) of 4,4′-isopropylidene-biscyclohexylamine (IPCD; BASF, technical grade, isomer mixture; amine content 7.77 mmol N/g) were added slowly from a heated dropping funnel, in the course of which the mixture heated up and became increasingly cloudy. Thereafter, the volatile constituents were removed under reduced pressure (10 mbar, 80° C.). Yield: 61.0 g of a clear, light brown oil with an amine content of 2.47 mmol N/g.

IR: 2954sh, 2921, 2852, 2822sh, 1737 (C═O), 1666 (C═N), 1466, 1448sh, 1418, 1393sh, 1377sh, 1343, 1300, 1249, 1234, 1159, 1112, 1085, 1058, 1021, 999, 974sh, 937, 898, 871sh, 761br, 721, 685.

Dialdimine A-7 (Corresponding to the Formula (I))

A round-bottom flask was initially charged under a nitrogen atmosphere with 25.8 g (0.09 mol) of distilled 2,2-dimethyl-3-lauroyloxy-propanal. With vigorous stirring, 5 g (0.09 mol of N) of solid trans-1,4-diaminocyclohexane (Invista; amine content 17.25 mmol N/g) were added in portions, the resulting suspension was heated to 80° C. and the volatile constituents were removed under reduced pressure (10 mbar, 80° C.). Yield: 28.7 g of a clear, pale brown oil with an amine content of 2.92 mmol N/g, which solidifies to a crystalline white mass within a few minutes when left to stand.

Melting point (uncorrected): 47-50° C.

IR: 2953sh, 2922, 2852, 2824sh, 1736 (C═O), 1664 (C═N), 1466, 1454sh, 1418, 1394, 1376, 1364sh, 1346, 1304, 1248, 1232, 1158, 1110, 1086, 1020, 1000, 942, 894, 887sh, 769, 722, 668.

Dialdimine A-8

A round-bottom flask was initially charged under a nitrogen atmosphere with 50.9 g (0.18 mol) of distilled 2,2-dimethyl-3-lauroyloxy-propanal. With vigorous stirring, 10.0 g (0.17 mol of N) of 1,6-hexamethylenediamine (BASF; amine content 17.04 mmol N/g) were added slowly from a heated dropping funnel, in the course of which the mixture heated up and became increasingly cloudy. Thereafter, the volatile constituents were removed under reduced pressure (10 mbar, 80° C.). Yield: 57.7 g of a clear, pale yellow oil with an amine content of 2.94 mmol N/g.

Dialdimine A-9

A round-bottom flask was initially charged under a nitrogen atmosphere with 74.3 g (0.26 mol) of distilled 2,2-dimethyl-3-lauroyloxy-propanal. With vigorous stirring, 30.0 g (0.25 mol of N) of polyetherdiamine (polyoxypropylenediamine with a mean molecular weight of approx. 240 g/mol; Jeffamine® D-230, Huntsman; amine content 8.29 mmol N/g) were added slowly from a dropping funnel, in the course of which the mixture heated up and became increasingly cloudy. Thereafter, the volatile constituents were removed under reduced pressure (10 mbar, 80° C.). Yield: 99.5 g of a clear, pale yellow oil with an amine content of 2.50 mmol N/g.

### b) Production of Polyurethane Compositions

### Examples 1 to 2 and comparative example 3

### Coating Materials

For each example, the particular constituents of the coating material according to table 1 were weighed in the parts by weight specified without previous drying into a screwtop polypropylene cup and mixed by means of a centrifugal mixer (SpeedMixer™ DAC 150, FlackTek Inc.; 1 minute at 2500 rpm), and the mixture was transferred immediately into an internally coated aluminum tube which was sealed airtight.

The polyurethane polymer P1 was prepared as follows:

1060 g of polyoxypropylenediol (Desmophen® 1111 BD, Bayer; OH number 111.4 mg KOH/g), 650 g of polyoxypropylenediol (Desmophen® 2061 BD, Bayer; OH number 56.1 mg KOH/g), 770 g of isophorone diisocyanate (Vestanat® IPDI, Degussa) and 0.25 g of dibutyltin dilaurate were converted at 80° C. to an NCO-terminated polyurethane polymer with a content of free isocyanate groups of 6.8% by weight.

TABLE 1
Composition of the coating materials of examples
1 to 2 and of comparative example 3.

| | Example | | |
|---|---|---|---|
| | | | 3 |
| | 1 | 2 | (Comparative) |
| Polyurethane polymer P1 | 48.0 | 48.0 | 48.0 |
| IPDI trimer^{a} | 27.0 | 27.0 | 27.0 |
| Dialdimine | A-1, | A-2, | A-8, |
| | 21.0 | 21.0 | 21.0 |
| Acid catalyst^{b} | 1.0 | 1.0 | 1.0 |
| Amine catalyst^{c} | 1.0 | 1.0 | 1.0 |
| Tin catalyst^{d} | 0.5 | 0.5 | 0.5 |
| Defoamer^{e} | 1.5 | 1.5 | 1.5 |

^{a}45% by weight of IPDI trimer (Vestanat ® T 1890/100, Degussa; NCO content = 17.3% by weight) in xylene.
^{b}5% by weight of salicylic acid in dioctyl adipate.
^{c}2,2′-dimorpholinodiethyl ether (DABCO ® DMDEE Catalyst, Air Products).
^{d}10% by weight of dibutyltin dilaurate in diisodecyl phthalate.
^{e}BYK-088 (BYK-Chemie/ALTANA).

The coating materials thus obtained were tested for skin formation time, mechanical properties in the cured state and yellowing.

To determine the skin formation time (“tack-free time”), a small portion of the coating material at room temperature, which had been stored at 40° C. over two hours, was applied in a layer thickness of approximately 2 mm to cardboard, and the time taken, at 23° C. and 50% relative air humidity, for no residues to remain on the pipette for the first time when the surface of the coating material is tapped gently with an LDPE pipette was determined.

To determine the mechanical properties after curing, the Shore A hardness, the tensile strength, the elongation at break and the modulus of elasticity were measured. The Shore A hardness was determined to DIN 53505 on a specimen cured over 28 days under standard climatic conditions (23° C., 50% relative air humidity). To test the further mechanical properties, the coating material, two hours after production, was cast in a planar PTFE mold to a film of thickness approx. 2 mm, and the film was cured under standard climatic conditions over 21 days and tested to DIN EN 53504 for tensile strength, elongation at break and modulus of elasticity (pulling speed: 200 mm/min).

Yellowing was tested qualitatively, by storing pieces of the completely cured coating material behind a sunlit window during daylight over four months, and then comparing with the color of pieces of the same material which had been stored in the dark. The material was assessed as unyellowed when no significant difference in the shade could be detected in this comparison.

Also assessed in a qualitative manner was bubble formation (with reference to the amount of bubbles which occurred during the curing of the film), as was odor formation (by smelling with the nose at a distance of 10 cm from the cured film).

The results of these tests are listed in table 2.

TABLE 2
Properties of the coating materials of examples
1 to 2 and of comparative example 3.

| | Example | | |
|---|---|---|---|
| | | | 3 |
| | 1 | 2 | (Comparative) |
| Skin formation time (min.) | 195 | 165 | 160 |
| Shore A hardness | 76 | 88 | 66 |
| Tensile strength (MPa) | 11.7 | 13.5 | 8.8 |
| Elongation at break (%) | 350 | 300 | 310 |
| Modulus of elasticity (MPa)^{a} | 48 | 67 | 18 |
| Bubble formation | none | none | none |
| Odor formation | none | none | none |
| Yellowing | none | none | none |

^{a}at 0.5-5.0% extension.

It is evident from table 2 that the inventive coating materials of examples 1 and 2 have a significantly higher tensile strength and a higher modulus of elasticity compared to those of comparative example 3 coupled with at least equally good elongation at break.

### Examples 4 to 7 and Comparative Examples 8 to 9

### Elastic Adhesives

For each example, the particular constituents according to table 3 were processed in the parts by weight specified without previous drying in a vacuum mixer with exclusion of moisture to give a homogeneous paste, which was immediately transferred to an internally coated aluminum cartridge which was sealed airtight.

The polyurethane polymer P2 was prepared as follows:

590 g of Acclaim® 4200 N polyol (polypropylene oxide diol, OH number 28.5 mg KOH/g; Bayer), 1180 g of Caradol® MD34-02 polyol (polypropylene oxide-polyethylene oxide triol, OH number 35.0 mg KOH/g; Shell) and 230 g of isophorone diisocyanate (IPDI; Vestanat® IPDI, Degussa) were converted by the known method at 80° C. to an NCO-terminated polyurethane polymer with a content of free isocyanate groups determined by titrimetric means of 2.1% by weight and a viscosity at 20° C. of 22 Pa·s.

The urea thickener was prepared as follows:

A vacuum mixer was initially charged with 3000 g of diisodecyl phthalate (DIDP; Palatinol® Z, BASF) and 480 g of 4,4′-methylenediphenyl diisocyanate (MDI; Desmodur® 44 MC L, Bayer), which were heated gently. Then 270 g of monobutylamine were slowly added dropwise with vigorous stirring. The paste which formed was stirred under vacuum with cooling for a further hour.

TABLE 3
Composition of the elastic adhesives of examples
4 to 7 and of comparative examples 8 to 9.

| | Example | | | | | |
|---|---|---|---|---|---|---|
| | | | | | 8 | 9 |
| | 4 | 5 | 6 | 7 | (Comp.) | (Comp.) |
| Polyurethane polymer | 35.0 | 35.0 | 35.0 | 35.0 | 35.0 | 35.0 |
| P2 | | | | | | |
| Dialdimine | A-1, | A-2, | A-3, | A-4, | A-9, | — |
| | 4.17 | 4.37 | 3.87 | 4.56 | 4.56 | |
| Crosslinker^{a} | 0.8 | 0.8 | 0.8 | 0.8 | 0.8 | 0.8 |
| Chalk | 27.0 | 27.0 | 27.0 | 27.0 | 27.0 | 27.0 |
| Thickener^{b} | 26.83 | 26.63 | 27.13 | 26.44 | 26.44 | 31.50 |
| Titanium dioxide | 4.5 | 4.5 | 4.5 | 4.5 | 4.5 | 4.5 |
| Epoxysilane^{c} | 0.2 | 0.2 | 0.2 | 0.2 | 0.2 | 0.2 |
| Acid catalyst^{d} | 1.0 | 1.0 | 1.0 | 1.0 | 1.0 | — |
| Tin catalyst^{e} | 0.5 | 0.5 | 0.5 | 0.5 | 0.5 | 1.0 |

^{a}HDI trimer (Desmodur ® N-3600, Bayer), NCO content = 23.0% by weight.
^{b}Urea thickener.
^{c}3-glycidoxypropyltriethoxysilane (Dynasylan ® GLYEO, Degussa).
^{d}Salicylic acid (5% by weight in dioctyl adipate).
^{e}Dibutyltin dilaurate (5% by weight in diisodecyl phthalate).

The ratio between the isocyanate groups in the polyurethane polymer P2 and the sum of the reactive groups (aldimino groups plus hydroxyl groups) in the dialdimines of the formula (I) is 1.0/0.52 for all examples.

The elastic adhesives thus obtained were tested for creep resistance, threading, skin formation time, curing rate, mechanical properties after curing, tack and staining.

To determine the creep resistance, the adhesive was applied by means of a cartridge pistol through a triangular nozzle as a horizontal triangular bead with a base diameter of 8 mm and a height (distance of the triangular tip from the base) of 20 mm onto a vertical piece of cardboard. After five minutes, the extent to which the tip had lowered, i.e. had moved away from the original position in the middle of the triangular bead, was measured. It was assessed as “very good” when the tip was in a completely or nearly unchanged position, and as “good” when the tip was between the middle and the end of the base.

Threading was determined qualitatively by applying a little adhesive by means of a cartridge pistol onto a piece of cardboard secured to a wall, pulling the cartridge pistol away from the adhesive applied by pulling it back rapidly at the end of application, and measuring the length of the adhesive thread which remained at the severance point.

The skin formation time was determined as described in example 1.

The curing rate (through-curing) was determined by applying the adhesive by means of a cartridge pistol through a round tip (opening 10 mm) as a horizontal, free-hanging cone with a length of approx. 50 mm and a thickness in the middle of 30 mm to a piece of cardboard secured to a wall, leaving under standard climatic conditions over seven days, then cutting vertically down the middle, and measuring the thickness of the cured adhesive layer with a ruler.

To determine the mechanical properties after curing, Shore A hardness, tensile strength, elongation at break and modulus of elasticity were measured. The Shore A hardness was determined to DIN 53505 on a specimen cured under standard climatic conditions over 14 days. To test the further mechanical properties, the adhesive, two hours after production, was pressed by means of a press to a film of thickness approx. 2 mm, and the film was cured under standard climatic conditions over 14 days and tested to DIN EN 53504 for tensile strength, elongation at break and modulus of elasticity (pulling speed: 200 mm/min).

The tack of the adhesive surface was tested by pressing the curing Shore A specimen with the thumb one day after the application thereof, and then determining how long the specimen remained adhering on the thumb as the hand was raised. The tack was then rated as high (specimen remains adhering for more than 3 seconds), medium (specimen remains adhering for about 3 seconds), low (specimen remains adhering for 1 to 2 seconds) and none (specimen remains adhering for less than 1 second).

Staining was assessed using the size (large/medium/small/none) of the grease ring which had formed one week after the application of the Shore A specimen to the sheet of paper to which the specimen had been applied.

The results of the tests are listed in table 4.

TABLE 4
Properties of the elastic adhesives of examples
4 to 7 and of comparative examples 8 to 9.

| | Example | | | | | |
|---|---|---|---|---|---|---|
| | | | | | 8 | 9 |
| | 4 | 5 | 6 | 7 | (Comp.) | (Comp.) |
| Creep resistance | very | very | very | very | very | very |
| | good | good | good | good | good | good |
| Threading (cm) | 3 | 5 | 3 | 3 | 3 | 3.5 |
| Skin formation time | 190 | 90 | 125 | 320 | 135 | >480 |
| (min.) | | | | | | |
| Through-curing (mm) | 8 | 9 | 7 | 6 | 8 | 9 |
| Shore A hardness | 43 | 53 | 46 | 51 | 33 | 45 |
| Tensile strength (MPa) | 2.2 | 2.3 | 2.6 | 3.0 | 2.1 | n.m.^{b} |
| Elongation at break (%) | 640 | 500 | 760 | 700 | 680 | n.m.^{b} |
| Modulus of elasticity | 3.0 | 6.1 | 4.9 | 7.2 | 2.6 | n.m.^{b} |
| (MPa)^{a} | | | | | | |
| Tack | none | none | none | none | high | high |
| Staining | small | none | none | none | medium | large |

^{a}at 0.5-5.0% extension.
^{b}not measurable owing to significant bubble formation.

It is evident from Table 4 that the inventive elastic adhesives of examples 4 to 7, each of which contains a cycloaliphatic primary dialdimine of the formula (I), with otherwise similar properties, have a significantly higher Shore A hardness and a higher modulus of elasticity, are less tacky after one day and exhibit less staining compared to the adhesive of comparative example 8 which comprises a noncycloaliphatic dialdimine. Compared to the adhesive of comparative example 9, which contains no dialdimine at all, the inventive elastic adhesives of examples 4 to 7 possess a shorter skin formation time, bubble-free curing, better mechanical properties, lower tack and less staining.

### Examples 10 to 11 and Comparative Example 12

### Elastic Sealants

For each example, the particular constituents according to table 5 were processed in the parts by weight specified without previous drying in a vacuum mixer with exclusion of moisture to give a homogeneous paste, which was immediately transferred into an internally coated aluminum cartridge which was sealed airtight.

The polyurethane polymer P3 was prepared as follows:

580 g of Acclaim® 4200 N polyol (polypropylene oxide diol, OH number 28.5 mg KOH/g; Bayer), 303 g of Caradol® MD34-02 polyol (polypropylene oxide-polyethylene oxide triol, OH number 35.0 mg KOH/g; Shell) and 117 g of isophorone diisocyanate (IPDI; Vestanat® IPDI, Degussa) were converted by the known method at 80° C. to an NCO-terminated polyurethane polymer with a content of free isocyanate groups determined by titrimetry of 2.25% by weight and a viscosity at 20° C. of 10 Pa·s.

The urea thickener was prepared as described in example 4.

The ratio between the isocyanate groups in the polyurethane polymer P3 and the sum of the reactive groups (aldimino groups plus hydroxyl groups) in the dialdimines of the formula (I) is 1.0/0.67 for all examples.

TABLE 5
Composition of the elastic sealants of examples
10 to 11 and of comparative example 12.

| | Example | | |
|---|---|---|---|
| | | | 12 |
| | 10 | 11 | (Comparative) |
| Polyurethane polymer P3 | 24.0 | 24.0 | 24.0 |
| Dialdimine | A-1, | A-5, | A-9, |
| | 3.24 | 3.44 | 3.54 |
| Plasticizer^{a} | 1.76 | 1.56 | 1.46 |
| Chalk | 38.0 | 38.0 | 38.0 |
| Thickener^{b} | 28.0 | 28.0 | 28.0 |
| Titanium dioxide | 4.5 | 4.5 | 4.5 |
| Epoxysilane^{c} | 0.2 | 0.2 | 0.2 |
| Acid catalyst^{d} | 0.3 | 0.3 | 0.3 |

^{a}Diisodecyl phthalate (DIDP; Palatinol ® Z, BASF).
^{b}Urea thickener.
^{c}3-glycidoxypropyltriethoxysilane (Dynasylan ® GLYEO, Degussa).
^{d}Salicylic acid (5% by weight in dioctyl adipate).

The elastic sealants thus obtained were tested for creep resistance, threading, skin formation time, curing rate, mechanical properties after curing, tack and staining.

The mechanical properties were determined as described in example 4, except that, instead of the modulus of elasticity, the extension stress at 100% extension was determined.

The remaining tests were effected as described in example 4, except that the test of tack was additionally carried out on the three-day-old Shore A specimen.

All sealants cured completely without bubbles.

The results of the tests are listed in table 6.

TABLE 6
Properties of the elastic sealants of examples
10 to 11 and of comparative example 12.

| | Example | | |
|---|---|---|---|
| | | | 12 |
| | 10 | 11 | (Comparative) |
| Creep resistance | good | good | good |
| Threading (cm) | 6 | 6 | 4 |
| Skin formation time (min.) | 330 | 220 | 180 |
| Through-curing (mm) | 7 | 8 | 4 |
| Shore A hardness | 27 | 18 | 11 |
| Tensile strength (MPa) | 2.1 | 1.0 | n.m.^{a} |
| Elongation at break (%) | 1140 | 1200 | n.m.^{a} |
| Extension stress at 100% | 0.77 | 0.52 | n.m.^{a} |
| extension (MPa) | | | |
| Tack after 1 day | low | low | high |
| Tack after 3 days | low | low | high |
| Staining | small | small | small |

^{a}not measurable (too soft, tacky).

It is evident from table 6 that the inventive elastic sealants of examples 10 to 11, each of which comprises a cycloaliphatic dialdimine of the formula (I), have better mechanical properties and a significantly lower tack after 1 day or 3 days compared to the sealant of comparative example 12 which comprises a noncycloaliphatic dialdimine. The sealant of example 10, which comprises a cycloaliphatic dialdimine of the formula (I) in which one of the aldimino groups is bonded directly to a cycloaliphatic ring, is notable for the mechanical properties, especially the tensile strength, compared to the sealant of example 11, which comprises a cycloaliphatic dialdimine of the formula (I) in which none of the aldimino groups is bonded directly to a cycloaliphatic ring.

1. A composition comprising
at least one polyurethane polymer P which has cycloaliphatic isocyanate groups;
and at least one cycloaliphatic dialdimine of the formula (I) 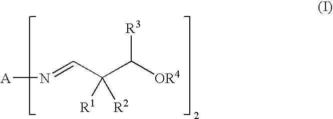
where R¹ and R²
are each independently a monovalent hydrocarbon radical having 1 to 12 carbon atoms;
or together are a divalent hydrocarbon radical which has 4 to 20 carbon atoms and is part of an optionally substituted carbocyclic ring having 5 to 8 carbon atoms;
R³ is a hydrogen atom or an alkyl or arylalkyl group;
R⁴
is a hydrocarbon radical which has 6 to 30 carbon atoms and optionally contains heteroatoms;
or is a radical of the formula (II) 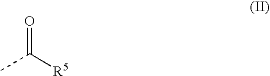
where R⁵
is a linear or branched alkyl radical having 6 to 30 carbon atoms, optionally having cyclic components and optionally having at least one heteroatom, ester or aldehyde groups;
or is a mono- or polyunsaturated linear or branched hydrocarbon radical having 6 to 30 carbon atoms;
or is an optionally substituted aromatic or heteroaromatic 5- or 6-membered ring;
and A is the radical of a cycloaliphatic primary diamine after removal of the two primary amino groups, where this radical does not have any moieties which are reactive with isocyanate groups.

2. The composition as claimed in claim 1, wherein A has no hydroxyl groups, no primary or secondary amino groups, no mercapto groups, no urea groups and no other groups with active hydrogen.

3. The composition as claimed in claim 1, wherein the polyurethane polymer P is prepared from at least one polyol and at least one cycloaliphatic diisocyanate.

4. The composition as claimed in claim 3, wherein the polyol is a polyesterpolyol or a polyetherpolyol.

5. The composition as claimed in claim 3, wherein the cycloaliphatic diisocyanate is selected from the group consisting of cyclohexane 1,3-diisocyanate, cyclohexane 1,4-diisocyanate, 1-isocyanato-3,3,5-trimethyl-5-isocyanatomethylcyclohexane (IPDI), perhydro-2,4′-diphenylmethane diisocyanate, perhydro-4,4′-diphenylmethane diisocyanate, 1,4-diisocyanato-2,2,6-trimethylcyclohexane, 2-methyl-1,3-diisocyanatocyclohexane and 4-methyl-1,3-diisocyanatocyclohexane, perhydro-2,4′-diphenylmethane diisocyanate and perhydro-4,4′-diphenylmethane diisocyanate.

6. The composition as claimed in claim 1, wherein R¹ and R² are each methyl groups.

7. The composition as claimed in claim 1, wherein R³ is a hydrogen atom.

8. The composition as claimed in claim 1, wherein R⁴ is a radical of the formula (II), where R⁵ is an alkyl group having 11 to 30 carbon atoms.

9. The composition as claimed in claim 1, wherein
R¹ and R² are each methyl groups;
R³ is a hydrogen atom;
and R⁴ is a radical of the formula (I), where R⁵ is an alkyl group having 11 to 30 carbon atoms.

10. The composition as claimed in claim 1, wherein the cycloaliphatic dialdimine is prepared by a condensation reaction between at least one cycloaliphatic primary diamine of the formula H₂N-A-NH₂ and at least one aldehyde of the formula (III).

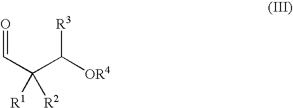

11. The composition as claimed in claim 10, wherein the cycloaliphatic primary diamine is selected from the group consisting of 1,2-diaminocyclohexane (DCH), 1,3-diaminocyclohexane, 1,4-diaminocyclohexane, bis(4-aminocyclohexyl)methane (H12MDA), bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (IPDA), 2,2′-, 2,4′- and 4,4′-diaminobicyclohexyl, 2- and 4-methyl-1,3-diaminocyclohexane and 1,4-diamino-2,2,6-trimethylcyclohexane, especially DCH, 1,3-diaminocyclohexane, 1,4-diaminocyclohexane, IPDA, H12MDA and bis(4-amino-3-methylcyclohexyl)methane.

12. The composition as claimed in claim 1, wherein the proportion of the polyurethane polymer P is 10 to 95% by weight based on the overall composition.

13. The composition as claimed in claim 1, wherein the ratio between the aldimino groups of the dialdimine of the formula (I) and the isocyanate groups of the polyurethane polymer P has a value of 0.1 to 1.1.

14. The composition as claimed in claim 1, wherein the composition comprises at least one filler based on the overall composition.

15. The composition as claimed in claim 14, wherein the filler is carbon black.

16. The composition as claimed in claim 14, wherein the filler is barium sulfate (barite), quartz flour or a calcium carbonate.

17. The composition as claimed in claim 14, wherein the filler is a flame-retardant filler.

18. The composition as claimed in claim 1, wherein the composition is self-leveling at room temperature.

19. A cured composition obtained from the reaction of water with a composition as claimed in claim 1.

20. An adhesive, sealant and/or coating for construction and industrial applications made with the composition as claimed in claim 1.

21. A process for adhesive bonding of substrates S1 and S2, comprising the steps of
i) applying a composition as claimed in claim 1 to a substrate S1 and/or a substrate S2;
ii) contacting the substrates S1 and S2 via the composition applied; and
iii) curing the composition applied by means of water;
where the substrates S1 and S2 are the same or different from one another.

22. A process for sealing, comprising the steps of
i′) applying a composition as claimed in claim 1 between a substrate S1 and a substrate S2; and
ii′) curing the composition applied by means of water;
where the substrates S1 and S2 are the same or different from one another.

23. A process for producing a coating comprising the steps of
i″) applying a composition as claimed in claim 1 to a substrate S1, and
ii″) curing the composition applied by means of water.

24. The process as claimed in claim 21, wherein substrate S1 and/or S2 is selected from the group consisting of concrete, cement, mortar, brick, tile, gypsum, natural stone, asphalt, metal, metal alloy, wood, ceramic, glass, plastic, powder coating, paint and lacquer.

25. The process as claimed in claim 21, wherein substrate S1 and/or S2 has an undercoat.

26. The process as claimed in claim 23, wherein the step i″) of applying the composition is effected several times in succession.

27. The process as claimed in claim 23, wherein it additionally comprises a step of applying a seal, which is effected after the last step i″) of applying the composition.

28. An article which has been adhesively bonded, sealed or coated by a process as claimed in claim 21.

29. The article as claimed in claim 28, wherein the article is a building or a built structure in construction or civil engineering, an industrially manufactured good or a consumer good.

30. The article as claimed in claim 28, wherein the article is a floor.
